(19) United States
(12) Patent Application Publication
(10) Pub. No.: US 2025/0067925 A1
(43) Pub. Date: Feb. 27, 2025

(54) PHOTONICS INTEGRATED CIRCUIT EMBEDDED IN A GLASS SUBSTRATE AND OPTICALLY COUPLED WITH A PHOTONIC WIRE BOND

(71) Applicant: Intel Corporation, Santa Clara, CA (US)

(72) Inventors: Chia-Pin CHIU, Tempe, AZ (US); Kaveh HOSSEINI, Livermore, CA (US)

(21) Appl. No.: 18/236,216

(22) Filed: Aug. 21, 2023

(51) Int. Cl. G02B 6/12; G02B 6/13

(52) U.S. Cl. CPC G02B 6/12004; G02B 6/13

(57) ABSTRACT

Embodiments herein relate to systems, apparatuses, techniques or processes for packages that include a glass substrate, with one or more photonic integrated circuits embedded into cavities within the glass substrate. Dies may be on the glass substrate and electrically coupled with the embedded photonic integrated circuits. Photonic wire bonds may optically couple the embedded photonic integrated circuits with one or more optical waveguides that are within the glass substrate. Other embodiments may be described and/or claimed.

Embodiments of the present disclosure generally relate to optical package assemblies, and in particular optical package assemblies that include photonic integrated circuit dies.

### BACKGROUND

Continued reduction in end-product size of mobile electronic devices such as smart phones and ultrabooks is a driving force for the development of reduced-size system in package components.

### BRIEF DESCRIPTION OF THE DRAWINGS

FIG. 1 illustrates a legacy implementation of a plurality of computing dies that are on a photonics integrated circuit (PIC) interposer layer that is on a substrate.

FIGS. 2A-2B illustrate plan, front, and side views of a package that includes a PIC embedded into a glass substrate, with a computing die on the glass substrate and on the PIC, where the PIC is optically coupled with waveguides in the glass substrate using a photonic wire bond (PWB), in accordance with various embodiments.

FIG. 3 illustrates a plan view of a plurality of computing dies coupled respectively with a plurality of PICs that are embedded into a glass substrate, in accordance with various embodiments.

FIG. 4 illustrates plan, front, and side views of a package that includes a PIC embedded into a glass substrate, with two computing dies on the glass substrate and on the PIC, in accordance with various embodiments.

FIGS. 5A-5C illustrate plan, front, and side views of a package that includes a PIC embedded into a glass substrate, with a compute die on the PIC and an electronic integrated circuit (EIC) on the PIC, in accordance with various embodiments.

FIGS. 6A-6B illustrate plan and front views of a package that includes multiple PICs embedded into a glass substrate, with a compute die on the multiple PICs, in accordance with various embodiments.

FIG. 7 illustrates an example of a process for manufacturing a package that includes a PIC embedded into a glass substrate with a compute die on the PIC and the glass substrate, in accordance with various embodiments.

FIG. 8 schematically illustrates a computing device, in accordance with embodiments.

### DETAILED DESCRIPTION

Embodiments of the present disclosure may generally relate to systems, apparatus, techniques and/or processes directed to packages that include optical interconnects between chiplets or dies within a package, which may be referred to as a multi-chip package (MCP), and also between packages that include optical interconnects between the packages. Embodiments include a PIC that may be embedded within a glass substrate, which may be a glass layer, with a die on the embedded PIC (EPIC) and the glass substrate. Embodiments may also include a photonic wire bond (PWB) that optically couples with the EPIC and with one or more optical waveguides within the glass substrate. In embodiments, the dies may include a graphics processor unit (GPU), central processing unit (CPU), application-specific integrated circuit (ASIC), field programmable gate array (FPGA), or high-bandwidth memory (HBM).

In some embodiments, the embedded PIC techniques may serve as a scalable, modular approach for optically interconnecting multiple dies on a glass substrate. In embodiments, by using a glass substrate, the size of the resulting package may not be limited due to substrate warpage issues that may occur with legacy organic substrates. In embodiments, the multiple dies may communicate with each other using optical data through the EPIC, which may reside in an open cavity within the glass substrate. The EPIC may then use a PWB to optically interconnect with waveguides within the glass substrate.

In embodiments, the modular architecture may be used to increase the number of interconnected dies on a same package substrate. In addition, overall pin count may be reduced for I/O communication because the dies are interconnected optically in the glass package, or optically connected to another package. In addition, a glass substrate that includes embedded low-loss optical waveguides, in conjunction with the PWB in the EPIC, may provide improved communication between the dies on the same package substrate. For example, because all the electrical signal communication is replaced by optical signals, the complex electrical routing in the legacy substrate design can be avoided. In addition, any two dies that may be far away from each other can communicate directly through optical, just like they are next to each other, with no constraint of the electrical routing that may exist in a legacy package. In addition, use of a PWB to bridge between the waveguide within the glass substrate and the EPIC may result in a lower cost assembly due to a broader tolerance if the respective waveguides are not in perfect alignment, for example if the EPIC and the glass substrate are not perfectly coplanar.

In addition, the glass substrate may be manufactured using a glass panel process, which is more affordable than a manufacturing a legacy interposer which is typically manufactured using a more expensive wafer process. During operation of the package, a closer coefficient of thermal expansion (CTE) between the silicon die and the glass substrate will also result in less substrate warpage, and may enable a larger overall package footprint. In addition, using PWB will provide additional layout and design flexibility.

In the following detailed description, reference is made to the accompanying drawings which form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use perspective-based descriptions such as top/bottom, in/out, over/under, and the like. Such descriptions are merely used to facilitate the discussion and are not intended to restrict the application of embodiments described herein to any particular orientation.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The term “coupled with,” along with its derivatives, may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. The term “directly coupled” may mean that two or more elements are in direct contact.

Various operations may be described as multiple discrete operations in turn, in a manner that is most helpful in understanding the claimed subject matter. However, the order of description should not be construed as to imply that these operations are necessarily order dependent.

As used herein, the term “module” may refer to, be part of, or include an ASIC, an electronic circuit, a processor (shared, dedicated, or group) and/or memory (shared, dedicated, or group) that execute one or more software or firmware programs, a combinational logic circuit, and/or other suitable components that provide the described functionality.

Various Figures herein may depict one or more layers of one or more package assemblies. The layers depicted herein are depicted as examples of relative positions of the layers of the different package assemblies. The layers are depicted for the purposes of explanation, and are not drawn to scale. Therefore, comparative sizes of layers should not be assumed from the Figures, and sizes, thicknesses, or dimensions may be assumed for some embodiments only where specifically indicated or discussed.

Various embodiments may include one or more articles of manufacture (e.g., non-transitory computer-readable media) having instructions, stored thereon, that when executed result in actions of any of the above-described embodiments. Moreover, some embodiments may include apparatuses or systems having any suitable means for carrying out the various operations of the above-described embodiments.

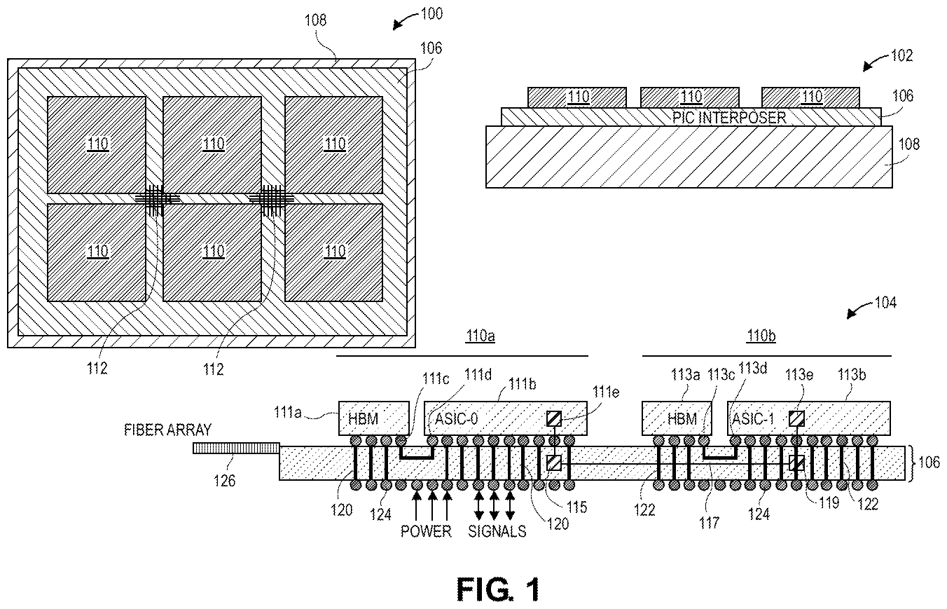

FIG. 1 illustrates a legacy implementation of a plurality of computing dies that are on a photonics integrated circuit (PIC) interposer layer that is on a substrate. Legacy package 100 shows a plan view of a plurality of dies 110 that are on top of a legacy PIC interposer 106 that is on a legacy organic substrate 108. In legacy implementations, there may be a single PIC interposer 106 onto which a plurality of dies 110 are placed. As discussed further below, the PIC interposer 106 may be a silicon-based interposer and may include electrical and/or optical routings 112 to couple the plurality of dies 110 with each other.

In legacy implementations, the organic substrate 108 may be made of organic small molecules or polymers, and may include polycyclic aromatic compounds such as pentacene, anthracene, and rubrene. In implementations, the organic substrate 108 may include glass fibers. The organic substrate 108 may be a standard organic substrate that includes multiple metal layers that may be used for electrical routing (not shown), where the multiple metal layers may be separated by dielectric material (not shown). As a result, the organic substrate 108 may be subject to warping due to operational conditions such as heat and humidity changes, as well as warping due to stresses experienced during the manufacturing process of the package.

Legacy package 102 shows a cross-section side view of legacy package 100, with the plurality of dies 110 on the PIC interposer 106, that in turn are on the organic substrate 108. The PIC interposer 106 is used to provide optical interconnects to route data from one chiplet to another that are on the organic substrate 108. Also, the organic substrate 108 may also provide photonics circuitry to optically interconnect from a package such as legacy package 100, to another package.

Legacy package 104 is a cross-section side view illustration of a portion of a package that may be similar to legacy packages 100, 102. Legacy package 104 includes the PIC interposer 106, that includes a first die 110a and a second die 110b, which may be similar to die 110, on the PIC interposer 106. In legacy implementations, the first die 110a includes a HBM 111a and an ASIC-0 111b that are electrically coupled with each other through the PIC interposer 106 through solder balls 111c, 111d. The second die 110b includes a HBM 113a that is coupled with an ASIC-1 113b through solder balls 113c, 113d.

The ASIC-0 111b of die 110a may also be optically coupled with the ASIC-1 113b of die 110b through the PIC interposer 106. In particular, a Universal Chiplet Interconnect Express (UCIe) implemented serializer/deserializer (SerDes) component 111e within the ASIC-0 111b may be electrically coupled with an optical transmitter component 115 within the PIC interposer 106, which generates a light signal that is transmitted along waveguide 117, which may be similar to optical routings 112, to an optical receiver 119 within the PIC interposer 106. Another UCIe SerDes component 113e is electrically coupled with the optical receiver 119. In this way, the die 110a may be optically coupled with the die 110b through the PIC interposer 106.

In addition, the PIC interposer 106 may include through silicon vias 120, 122 (TSVs) which include electrically conductive material, such as copper, to electrically couple solder balls 111c, 111d, 113c, 113d, with solder balls 124 on the opposite side of the PIC interposer 106. In some implementations, the TSVs 120, 122 may be used to route ground, power, and/or signals. The solder balls 124 may be physically and/or electrically coupled with the organic substrate 108 to form legacy packages 100, 102. The PIC interposer 106 may be optically coupled with a fiber array 126. Note that the legacy PIC interposer 106 may require reticle stitching for both electrical routing and optical connection when the required legacy PIC interposer 106 size is larger than a reticle size to accommodate multiple dies mounted on the top. In these legacy implementations, the reticle stitching process is complicated and may still limit the overall legacy PIC interposer 106 size.

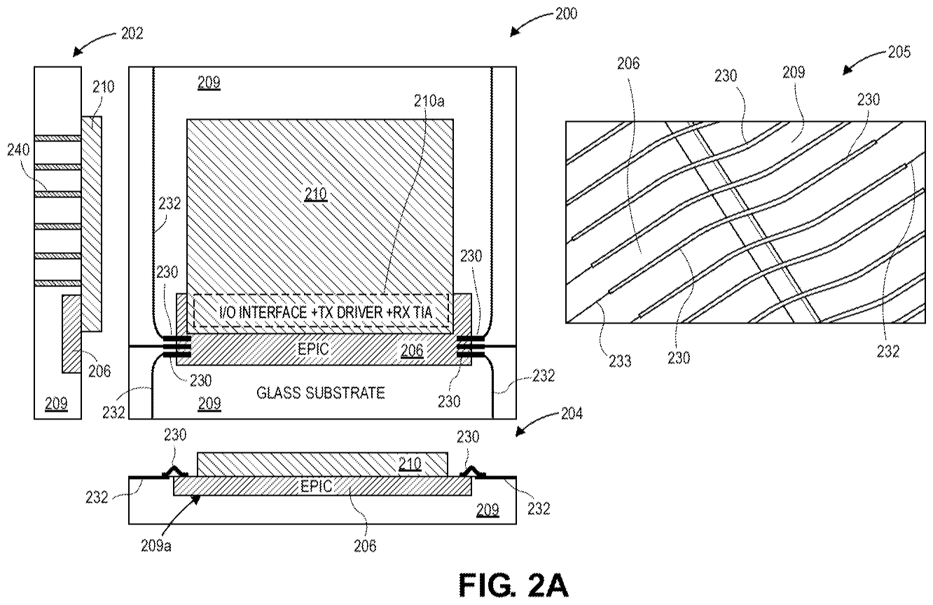

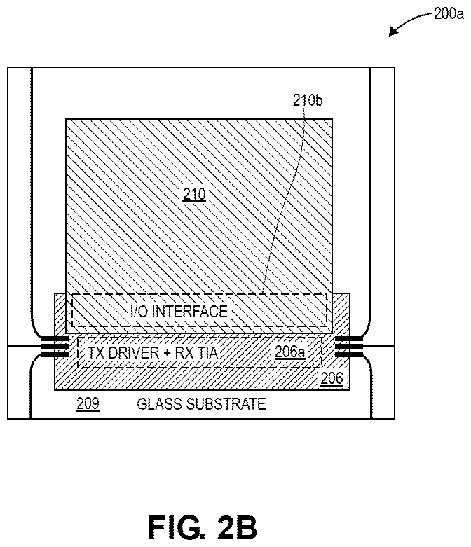

FIG. 2A illustrates plan, front, and side views of a package that includes a PIC embedded into a glass substrate, with a computing die on the glass substrate and on the PIC, where the PIC is optically coupled with waveguides in the glass substrate using a photonic wire bond (PWB), in accordance with various embodiments. Package 200 is a plan view diagram of an embodiment that shows a glass substrate 209 into which an EPIC 206 is embedded. In embodiments, the glass substrate 209 may be similar to organic substrate 108, and the EPIC 206 may be similar to PIC interposer 106 of FIG. 1.

In embodiments, a die 210, which may be similar to die 110 of FIG. 1, may be on the glass substrate 209 and on the EPIC 206. In embodiments, one or more PWB 230 may be coupled with the EPIC 206 and with the glass substrate 209, and in particular the one or more PWB 230 may optically couple the EPIC 206 with one or more optical waveguides 232 that are a part of the glass substrate 209. In embodiments, the optical waveguides 232 may be near a surface of the glass substrate 209, or may be formed in the interior of the glass substrate 209.

In embodiments, an I/O interface area 210a of the die 210 may be electrically coupled with the EPIC 206. In embodiments, this electrical coupling may be through solder ball connections (not shown), direct bonding that includes, but is not limited to copper to copper bonding, or hybrid bonding that includes, but is not limited to copper to copper bonding, and dielectric to dielectric bonding. In embodiments, the interface area 210a may include an I/O interface, as well as optical transmission driver, and/or an optical receiver transimpedance amplifier circuitry.

In embodiments, the I/O interface area 210a may be based upon Advanced Interface Bus (AIB), SerDes, or UCIe signaling standards, but may not be limited to those interface standards. In embodiments, the transmission driver, optical receiver transimpedance amplifier circuitry may be implemented within the die 210. In embodiments, the EPIC 206 may convert electrical I/O signaling to light signaling, and may include optical switches to reroute light from a source to many destinations.

Package 202 shows a side view illustration that shows through glass vias (TGV) 240, which may be similar to the TSV 120, 122 of FIG. 1, that extend through the glass substrate 209. In embodiments, the TGV 240 may be filled with electrically conductive material, and may be used to route ground, power, and/or signals to the die 210 on the glass substrate 209. In some embodiments, a through glass via (not shown) may electrically couple with the EPIC 206. In these embodiments, a PCB (not shown) coupled with the glass substrate 209 may have direct communication with EPIC 206 without routing through die 210. TSVs (not shown) will electrically couple with the EPIC 206 and the EPIC 206 also need TSVs (not shown) to electrically connect its bottom side to its top side.

Package 204 illustrates an end view that shows the die 210 on the EPIC 206, that is within a cavity 209a within the glass substrate 209. The waveguide 232 is at a top surface of the glass substrate 209, and optically coupled with the EPIC 206 using PWB 230. In other embodiments, at least a portion of the waveguide 232 may be in the interior of the glass substrate 209. In embodiments, a cavity 209a may be formed using laser and/or other etching techniques prior to the insertion of the EPIC 206 into the glass substrate 209. In embodiments, a top surface of the EPIC 206 may be flush, coplanar, or substantially planar with a top of the glass substrate 209. In some embodiments, the top surface of the EPIC 206 may not be coplanar with the top of a glass substrate 209.

In embodiments, a thickness of the die 210 may range from 200 μm to 775 μm, a thickness of the EPIC 206 may range from 50 μm to 250 μm, and a thickness of the glass substrate 209 may range from 0.8 mm to 2 mm. In embodiments, the glass substrate 209 may include a layer of glass, and may include selected one or more of: aluminosilicate, borosilicate, alumino-borosilicate, silica, and fused silica. In some embodiments, the glass of the glass substrate 209 may include one or more additives, such as Al₂O₃, B₂O₃, MgO, CaO, SrO, BaO, SnO₂, Na₂O, K₂O, SrO, P₂O₃, ZrO₂, Li₂O, Ti, and/or Zn. In some embodiments, the glass of the glass substrate 209 may include silicon and oxygen, as well as any one or more of: Aluminum, Boron, Magnesium, Calcium, Barium, Tin, Sodium, Potassium, Strontium, Phosphorus, Zirconium, Lithium, Titanium, and/or Zinc. In some embodiments, the glass of the glass substrate 209 may comprise at least 23 percent Silicon and at least 26 percent Oxygen by weight, and further may comprise at least 5 percent Aluminum by weight.

In some embodiments, the glass substrate 209 may be a solid layer of glass having a rectangular shape in a plan view. In embodiments, the glass substrate 209 may be a layer of glass that does not include an organic adhesive or an organic material. In embodiments, the glass of the glass substrate 209 may be an amorphous material.

Diagram 205 illustrates an example of a plurality of PWB 230 that may optically couple optical waveguide 232 of a glass substrate 209 with optical waveguide 233 of an EPIC 206. In embodiments, the waveguides 232, 233 do not need to line up with each other because the PWB 230 could make any alignment correction needed. In embodiments, multiple PWB 230 may not necessarily be parallel with each other, and in some embodiments may cross over each other to optically couple with other waveguides to change the order of a group of waveguides. Note that in diagram 205, the glass substrate 209 and the EPIC 206 may not be directly adjacent to each other, and also may be at different heights. In embodiments, the placement of the PWB 230 may be used to correct for these manufacturing defects or assembly tolerance and still supply reliable optical connections.

FIG. 2B illustrates a plan view of a package that includes a PIC embedded into a glass substrate, where the PIC may include electro-optical transmit driver circuitry and electro-optical receive TIA circuitry, in accordance with various embodiments. Package 200a, which may be similar to package 200 of FIG. 2A, is a plan view that shows EPIC 206 embedded into a glass substrate 209, with a die 210 on the glass substrate 209 and the EPIC 206. However, in this embodiment, the die 210 only includes I/O interface 210b, with the optical transmission driver, and/or an optical receiver transimpedance amplifier circuitry 206a located within the EPIC 206.

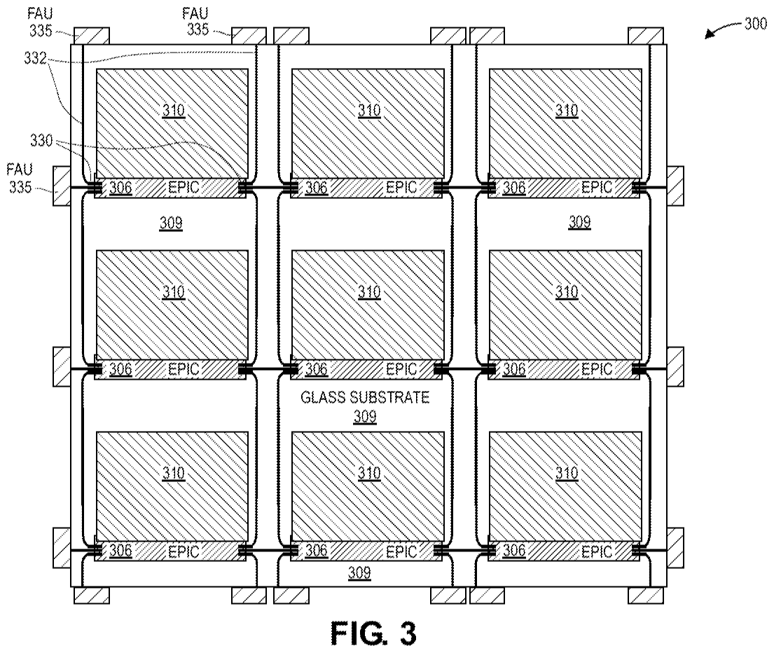

FIG. 3 illustrates a plan view of a plurality of computing dies coupled respectively with a plurality of PICs that are embedded into a glass substrate, in accordance with various embodiments. Package 300 shows a single glass substrate 309 that includes a plurality of EPIC 306 embedded within the glass substrate 309. In embodiments, each of a plurality of dies 310 may be coupled to the glass substrate 309 and coupled, respectively, to each of the EPICs 306 embedded within the glass substrate 309. The glass substrate 309, the EPICs 306, and the dies 310 may be similar to glass substrate 209, EPIC 206, and die 210 of FIG. 2A.

At least some of the plurality of EPICs 306 may include one or more PWB 330 that may be optically coupled to waveguides 332. These may be similar to PWB 230 and waveguide 232 of FIG. 2A. In embodiments, the waveguides 332 may directly couple two or more EPICs 306. In embodiments, the waveguides 332 may also couple with a fiber attach unit (FAU) 335 that may be on an edge of the glass substrate 309. In embodiments, each FAU 335 may couple with one or more optical cables (not shown).

In these embodiments, the glass substrate 309 may be manufactured at a larger size with little or no warping as compared to an organic substrate such as organic substrate 108 of FIG. 1. As a result, more dies 310 and EPICs 306 may be included on a single glass substrate 309. As a result, the size of the glass substrate 309 may exceed current legacy size limitations of traditional organic substrates. In embodiments, this larger size may be due in part to a closer coefficient of thermal expansion between the silicon dies 310 and the glass substrate 309. This allows a larger overall footprint for the package 300. In embodiments, the package 300 may be as large as a maximum size allowed for a glass panel manufacturing process.

In embodiments as shown, each die 310 may be optically coupled with a neighboring die 310, using an AIB interface. However, in other embodiments, each die 310 may be optically coupled with any other die, for example by using multiple EPIC dies 306 associated with any particular die 310, or by using multiple waveguides 332 that may be formed at different layers, or different levels, (not shown) within the glass substrate 309. Also, in embodiments, each of the dies 310 may be a same die or may be different dies. In embodiments, the dies 310 may include a system on chip (SOC) implementation.

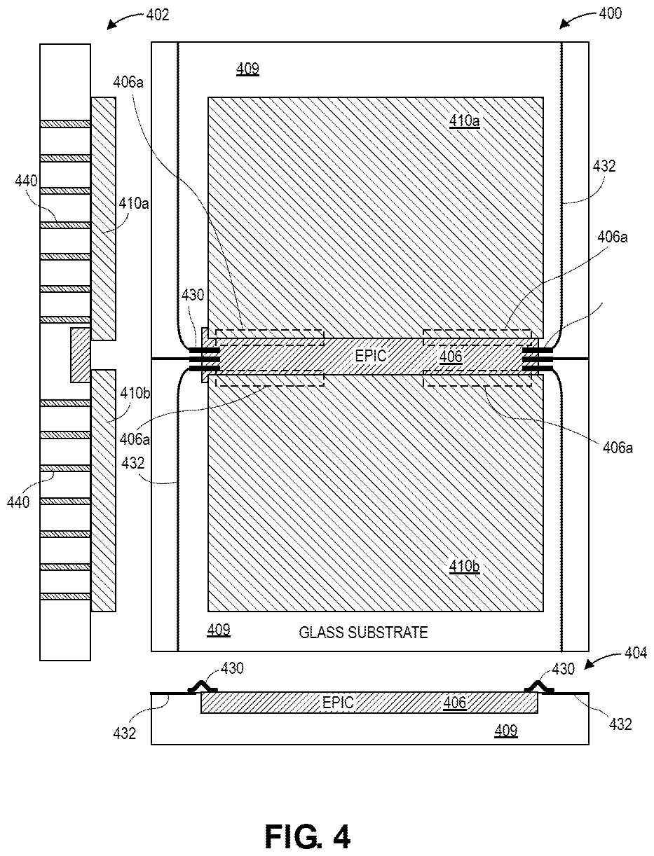

FIG. 4 illustrates plan, front, and side views of a package that includes a PIC embedded into a glass substrate, with two computing dies on the glass substrate and on the PIC, in accordance with various embodiments. Package 400 is a plan view that includes a glass substrate 409 with an EPIC 406 embedded within a cavity in the glass substrate 409. A first die 410a and a second die 410b are on the glass substrate 409, and also electrically coupled with the EPIC 406. The glass substrate 409, EPIC 406, and dies 410a, 410b may be similar to glass substrate 209, EPIC 206, and die 210 of FIG. 2A.

In embodiments, one or more PWB 430 may be optically coupled with the EPIC 406, and also optically coupled with one or more optical waveguides 432 that may be embedded within the glass substrate 409. Note that in some embodiments, one or more PWB 430 may not be present, and instead some other optical coupling technique may optically couple the EPIC 406 with the waveguide 432, for example an optical butt coupling (not shown). In some embodiments, a polymer waveguide (not shown) may be used as an optical coupling technique.

In embodiments, circuitry 406a within EPIC 406 may include circuitry and/or I/O interfaces that may be used to support communications between the dies 410a, 410b and the EPIC 406.

Package 402 shows a side view of package 400, that includes TGV 440, that may be similar to TGV 240 of FIG. 2A, that may provide ground, power, and/or signal to the dies 410a, 410b. Package 404 shows a cross-section end view of package 400. In some embodiments, die 410a and die 410b could communicate to each other through EPIC 406, without routing through the glass substrate 409. In these embodiments, the EPIC 406 may serve a similar function as a silicon bridge.

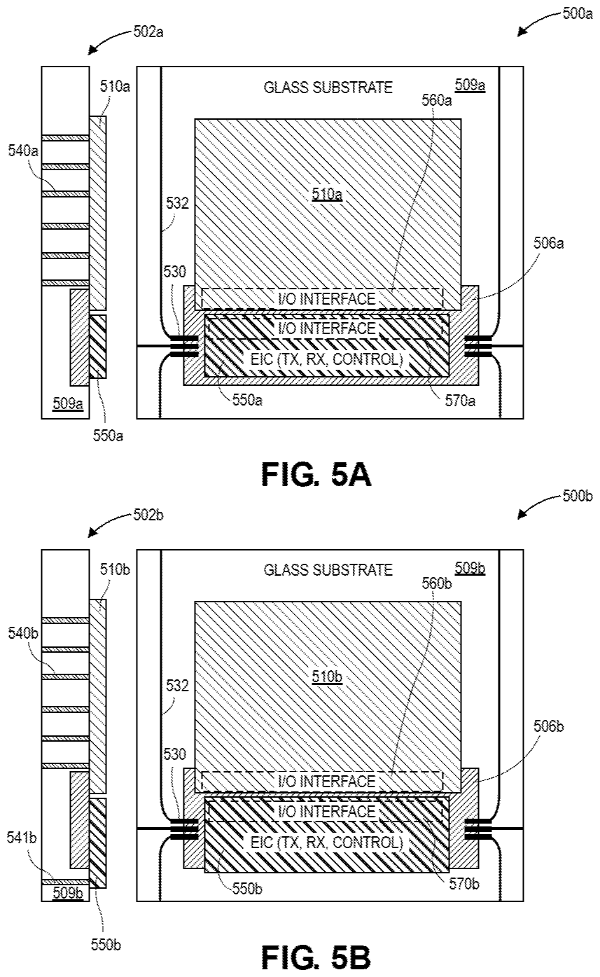

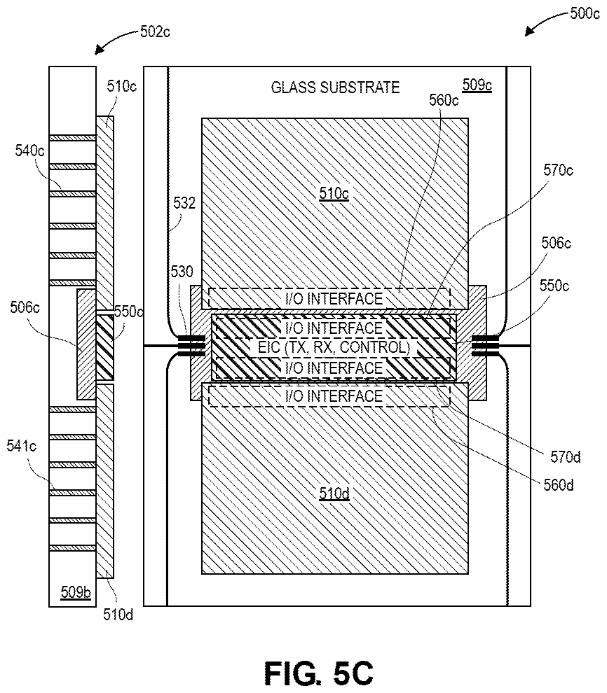

FIGS. 5A-5C illustrate plan, front, and side views of a package that includes a PIC embedded into a glass substrate, with a compute die on the PIC and an EIC on the PIC, in accordance with various embodiments. Package 500a includes a glass substrate 509a, and EPIC 506a that is embedded within a cavity within the glass substrate 509a, with a die 510a on the glass substrate 509a and electrically coupled with the EPIC 506a. In embodiments, the glass substrate 509a, EPIC 506a, and die 510a may be similar to glass substrate 209, EPIC 206, and die 210 of FIG. 2A.

In embodiments, an EIC 550a may be on the EPIC 506a and electrically coupled with the EPIC 506a. In embodiments, the EIC 550a may include only electronic circuitry, and no photonics circuitry. In embodiments, this arrangement may allow the EIC 550a to include all or part of electro-optical transmission driver circuitry, electro-optical receiver transimpedance amplifier circuitry, and/or electro-optical controller circuitry that otherwise may have been placed in the EPIC 506a. In embodiments, power that may be required for the operation of the EIC 550a may be received from the die 510a through the EPIC 506a. In embodiments, PWB 530 may optically couple the EPIC 506a with one or more waveguides 532, which may be similar to PWB 230 and waveguides 232 of FIG. 2A.

Package 502a shows a side view of package 500a that shows TGV 540a, which may be similar to TGV 440 of FIG. 4. In embodiments, the TGV 540a may be used to route power to the die 510a, which then may route power to the EIC 550a through the EPIC 506a. In embodiments, signals may be routed through an I/O interface 560a of the die 510a through the EPIC 506a, and through the I/O interface 570a of the EIC 550a. In some embodiments, the EIC 550a may be a laser module and the EPIC 506a may combine the function of a PIC and an EIC that may exclude the laser. In other embodiments, the EPIC 506a may combine all PIC and EIC functions, while the EIC 550a may be a heat spreader that may include silicon. In this embodiment, the EIC 550a may be used to conduct the thermal energy generated by the EPIC 506a to an integrated head spreader (IHS) or heat sink (not shown), but may be on the EIC 550a, or may be on the glass substrate 509a.

FIG. 5B shows package 500b, which may be similar to package 500a of FIG. 5A, with glass substrate 509b and embedded EPIC 506b within a cavity of the glass substrate 509b. The die 510b may be on the glass substrate 509b and on the EPIC 506b. In embodiments, an EIC 550b may be on the EPIC 506b and electrically coupled with the EPIC 506b. However, unlike the embodiment described in FIG. 5A, the EIC 550b may be at least partially on the glass substrate 509b. As a result, as shown in package 502b, a side view of package 500b, in addition to TGV 540b that may provide power to the die 510b, TGV 541b may also be used to provide power to the EIC 550b. In this way, in these embodiments, the I/O interface 560b of the die 510b and the I/O interface 570b of the EIC 550b may only need to route high speed signals. In embodiments, the die 510b and/or EIC 550b may be powered by independent power rails.

FIG. 5C illustrates plan and side views of a package that includes a PIC embedded into a glass substrate, with two compute dies on the PIC and a EIC on the PIC, in accordance with various embodiments. Package 500c, which may be similar to package 500b of FIG. 5B, includes a glass substrate 509c that includes an EPIC 506c that may be embedded into the glass substrate 509c.

In embodiments, a first die 510c and a second die 510d may be on the glass substrate 509c and on at least a portion of the EPIC 506c. In embodiments, an EIC 550c may be on the EPIC 506c, and may provide circuitry that may include transmit driver circuitry, receive TIA circuitry, and/or control circuitry for the EPIC 506c. In embodiments, the circuitry may be used to facilitate communications between the dies 510c, 510d, and the one or more PWB 530 that may be coupled with the EPIC 506c. In embodiments, the PWB 530 may be optically coupled with one or more waveguides 532.

In embodiments, an I/O interface 560c of the first die 510c may be electrically coupled with an I/O interface 570c of the EIC 550c, and an I/O interface 560d of the second die 510d may be electrically coupled with an I/O interface 570d of the EIC 550c. In these embodiments, both dies 510c, 510d may provide power to both the EPIC 506c and the EIC 550c.

In embodiments, as shown with respect to package 502c which is a side view of the package 500c, the first die 510c may be electrically coupled with one or more TGV 540c that extend through the glass substrate 509c. In embodiments, the second die 510d may be electrically coupled with one or more TGV 541c that extend through the glass substrate 509c. In embodiments, these techniques may be used to reduce the numbers of dies that may be mounted on the glass substrate 509c by sharing an EIC and an EPIC between die 510c and die 510d, as compared to the embodiments described in FIG. 5A.

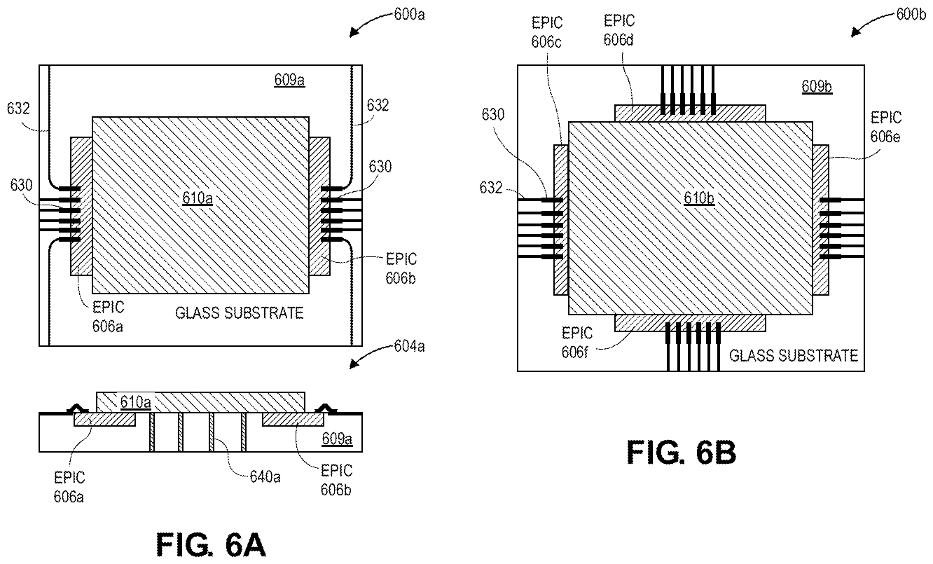

FIGS. 6A-6B illustrate plan and front views of a package that includes multiple PICs embedded into a glass substrate, with a compute die on the multiple PICs, in accordance with various embodiments. Package 600a of FIG. 6A shows a plan view that includes a glass substrate 609a, a first EPIC die 606a in a first cavity within the glass substrate 609a, and a second EPIC die 606b in a second cavity within the glass substrate 609a. In embodiments, a die 610a may be on the glass substrate 609a, and may be on and electrically coupled to the EPIC dies 606a, 606b. In embodiments, the glass substrate 609a, EPIC dies 606a, 606b, and die 610a may be similar to glass substrate 209, EPIC 206, and die 210 of FIG. 2A.

Package 604a shows a cross-section side view of package 600a, that includes TGV 640a that may be filled with an electrically conductive material, such as copper, to provide power, ground, signals, and/or other connections through the glass substrate 609a to the die 610a. In embodiments, there may be other TGV (not shown) that may provide power or other electrical connections to the EPIC dies 606a, 606b. In other embodiments, the EPIC dies 606a, 606b may be placed within a large cavity (not shown) within the glass substrate 609a, and a filler material, which includes but may not be limited to a bonding material or underfill material (not shown), may be placed between EPIC dies 606a, 606b.

In embodiments, the EPIC dies 606a, 606b may be connected to one or more waveguides 632 within the glass substrate 609a through one or more PWB 630, which may be similar to PWB 230 and waveguides 232 of FIG. 2A. In embodiments, the waveguides 632 may be near a surface of the glass substrate 609a, or may be formed within the interior of the glass substrate 609a. In embodiments, the two EPIC dies 606a, 606b may be coupled with a single die 610a, where the single die 610a is a system on chip (SOC) which may include one or more compute dies that may be coupled with one or more HBM (not shown), in order to provide higher communication bandwidth to the SOC.

FIG. 6B includes package 600b, which may be similar to package 600a, shows a plan view that includes a glass substrate 609b with multiple EPIC dies 606c, 606d, 606e, 606f that are embedded within the glass substrate 609b. In embodiments, a die 610b, which may be similar to die 610a of FIG. 6A, may be on the glass substrate 609b and electrically coupled with the multiple EPIC dies 606c, 606d, 606e, 606f. Similar to package 600a of FIG. 6A, die 610b may take the form of an SOC, where one or more of the multiple EPIC dies 606c, 606d, 606e, 606f may be electrically coupled with a component within the SOC.

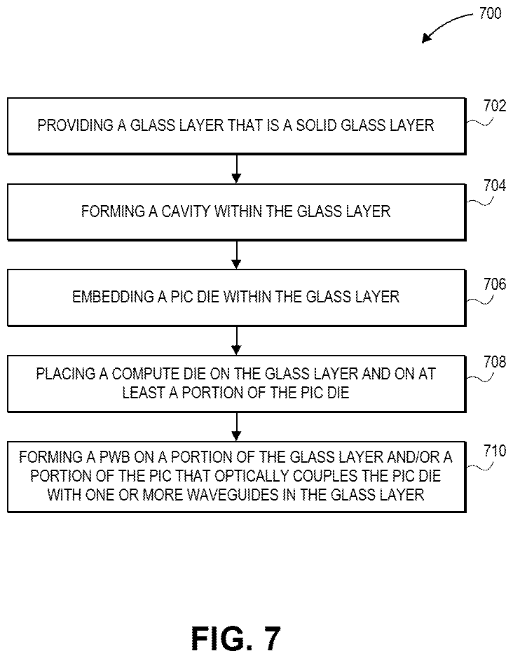

FIG. 7 illustrates an example of a process for manufacturing a package that includes a PIC embedded into a glass substrate with a compute die on the PIC and the glass substrate, in accordance with various embodiments. Process 700, in embodiments, may be implemented using the apparatus, systems, processes, and/or techniques described herein, and in particular with respect to FIGS. 1-6B.

At block 702, the process may include providing a glass substrate that is a solid glass substrate. In embodiments, the glass substrate may be similar to glass substrate 209 of FIGS. 2A-2B, glass substrate 309 of FIG. 3, glass substrate 409 of FIG. 4, glass substrates 509a, 509b, 509c of FIGS. 5A-5C, or glass substrates 609a, 609b of FIGS. 6A-6B.

At block 704, the process may further include forming a cavity within the glass substrate. In embodiments, the cavity may be similar to cavity 209a of FIG. 2A.

At block 706, the process may further include embedding a PIC die within the glass substrate. In embodiments, the PIC die may be similar to EPIC die 206 of FIGS. 2A-2B, EPIC dies 306 of FIG. 3, EPIC die 406 of FIG. 4, EPIC die 506a of FIG. 5A, EPIC die 506b of FIG.

5B, EPIC die 506c of FIG. 5C, EPIC dies 606a, 606b of FIG. 6A, or EPIC dies 606c, 606d, 606e, 606f of FIG. 6B.

At block 708, the process may further include placing a compute die on the glass substrate and on at least a portion of the PIC die. In embodiments, the compute die may be similar to die 210 of FIGS. 2A-2B, dies 310 of FIG. 3, dies 410a, 410b of FIG. 4, die 510a of FIG. 5A, die 510b of FIG. 5B, dies 510c, 510d of FIG. 5C, die 610a of FIG. 6A, or dies 606b of FIG. 6B.

At block 710, the process may further include forming a PWB on a portion of the glass substrate and/or a portion of the PIC that optically couples the PIC die with one or more waveguides in the glass substrate. In embodiments, the PWB may be similar to PWB 230 of FIG. 2A, PWBs 330 of FIG. 3, PWB 430 of FIG. 4, PWB 530 of FIGS. 5A-5C, or PWBs 630 of FIG. 6A-6B. In embodiments, the waveguides may be similar to waveguides 232 of FIG. 2A, waveguides 332 of FIG. 3, waveguides 432 of FIG. 4, waveguides 532 of FIGS. 5A-5C, or waveguides 632 of FIG. 6A-6B.

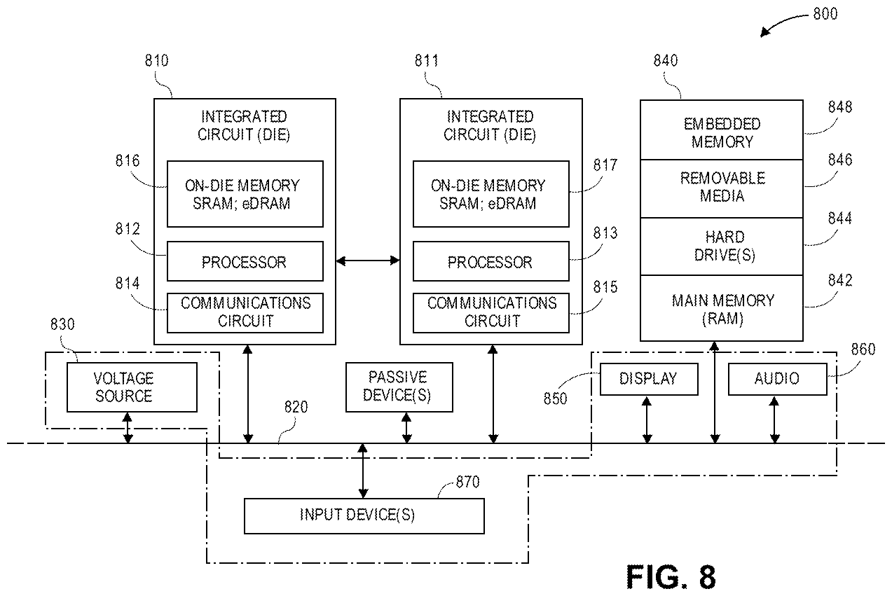

FIG. 8 is a schematic of a computer system 800, in accordance with an embodiment of the present disclosure. The computer system 800 (also referred to as the electronic system 800) as depicted can embody a PIC in a glass substrate and optically coupled with a PWB, according to any of the several disclosed embodiments and their equivalents as set forth in this disclosure. The computer system 800 may be a mobile device such as a netbook computer. The computer system 800 may be a mobile device such as a wireless smart phone. The computer system 800 may be a desktop computer. The computer system 800 may be a hand-held reader. The computer system 800 may be a server system. The computer system 800 may be a supercomputer or high-performance computing system.

In an embodiment, the electronic system 800 is a computer system that includes a system bus 820 to electrically couple the various components of the electronic system 800. The system bus 820 is a single bus or any combination of busses according to various embodiments. The electronic system 800 includes a voltage source 830 that provides power to the integrated circuit 810. In some embodiments, the voltage source 830 supplies current to the integrated circuit 810 through the system bus 820.

The integrated circuit 810 is electrically coupled to the system bus 820 and includes any circuit, or combination of circuits according to an embodiment. In an embodiment, the integrated circuit 810 includes a processor 812 that can be of any type. As used herein, the processor 812 may mean any type of circuit such as, but not limited to, a microprocessor, a microcontroller, a graphics processor, a digital signal processor, or another processor. In an embodiment, the processor 812 includes, or is coupled with, a PIC in a glass substrate and optically coupled with a PWB, as disclosed herein. In an embodiment, SRAM embodiments are found in memory caches of the processor. Other types of circuits that can be included in the integrated circuit 810 are a custom circuit or an application-specific integrated circuit (ASIC), such as a communications circuit 814 for use in wireless devices such as cellular telephones, smart phones, pagers, portable computers, two-way radios, and similar electronic systems, or a communications circuit for servers. In an embodiment, the integrated circuit 810 includes on-die memory 816 such as static random-access memory (SRAM). In an embodiment, the integrated circuit 810 includes embedded on-die memory 816 such as embedded dynamic random-access memory (eDRAM).

In an embodiment, the integrated circuit 810 is complemented with a subsequent integrated circuit 811. Useful embodiments include a dual processor 813 and a dual communications circuit 815 and dual on-die memory 817 such as SRAM. In an embodiment, the dual integrated circuit 810 includes embedded on-die memory 817 such as eDRAM.

In an embodiment, the electronic system 800 also includes an external memory 840 that in turn may include one or more memory elements suitable to the particular application, such as a main memory 842 in the form of RAM, one or more hard drives 844, and/or one or more drives that handle removable media 846, such as diskettes, compact disks (CDs), digital variable disks (DVDs), flash memory drives, and other removable media known in the art. The external memory 840 may also be embedded memory 848 such as the first die in a die stack, according to an embodiment.

In an embodiment, the electronic system 800 also includes a display device 850, an audio output 860. In an embodiment, the electronic system 800 includes an input device such as a controller 870 that may be a keyboard, mouse, trackball, game controller, microphone, voice-recognition device, or any other input device that inputs information into the electronic system 800. In an embodiment, an input device 870 is a camera. In an embodiment, an input device 870 is a digital sound recorder. In an embodiment, an input device 870 is a camera and a digital sound recorder.

As shown herein, the integrated circuit 810 can be implemented in a number of different embodiments, including a package substrate having a PIC in a glass substrate and optically coupled with a PWB, according to any of the several disclosed embodiments and their equivalents, an electronic system, a computer system, one or more methods of fabricating an integrated circuit, and one or more methods of fabricating an electronic assembly that includes a package substrate having a PIC in a glass substrate and optically coupled with a PWB, according to any of the several disclosed embodiments as set forth herein in the various embodiments and their art-recognized equivalents. The elements, materials, geometries, dimensions, and sequence of operations can all be varied to suit particular I/O coupling requirements including array contact count, array contact configuration for a microelectronic die embedded in a processor mounting substrate according to any of the several disclosed package substrates having a PIC in a glass substrate and optically coupled with a PWB embodiments and their equivalents. A foundation substrate may be included, as represented by the dashed line of FIG. 8. Passive devices may also be included, as is also depicted in FIG. 8.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

Various embodiments may include any suitable combination of the above-described embodiments including alternative (or) embodiments of embodiments that are described in conjunctive form (and) above (e.g., the “and” may be “and/or”). Furthermore, some embodiments may include one or more articles of manufacture (e.g., non-transitory computer-readable media) having instructions, stored thereon, that when executed result in actions of any of the above-described embodiments. Moreover, some embodiments may include apparatuses or systems having any suitable means for carrying out the various operations of the above-described embodiments.

The above description of illustrated embodiments, including what is described in the Abstract, is not intended to be exhaustive or to limit embodiments to the precise forms disclosed. While specific embodiments are described herein for illustrative purposes, various equivalent modifications are possible within the scope of the embodiments, as those skilled in the relevant art will recognize.

These modifications may be made to the embodiments in light of the above detailed description. The terms used in the following claims should not be construed to limit the embodiments to the specific implementations disclosed in the specification and the claims. Rather, the scope is to be determined entirely by the following claims, which are to be construed in accordance with established doctrines of claim interpretation.

### EXAMPLES

The following paragraphs describe examples of various embodiments.

Example 1 is an apparatus comprising: a glass layer having a first side and a second side opposite the first side, wherein the glass layer is a solid glass layer; a cavity in the glass layer, the cavity extending from the first side of the glass layer; a photonics integrated circuit (PIC) die in the cavity; a compute die on the first side of the glass layer and on at least a portion of the PIC die, wherein the PIC die is electrically coupled with the compute die; and wherein the PIC die is optically coupled with the glass layer.

Example 2 includes the apparatus of example 1, wherein the PIC die is optically coupled with the glass layer using a photonic wire bond.

Example 3 includes the apparatus of examples 1 and 2, wherein a surface of the PIC die is substantially planar with the first side of the glass layer.

Example 4 includes the apparatus of examples 1, 2, or 3, wherein the PIC die is electrically coupled with the compute die through the at least a portion of the PIC die.

Example 5 includes the apparatus of examples 1, 2, 3, or 4, wherein the PIC die is optically coupled with the compute die through the at least a portion of the PIC die.

Example 6 includes the apparatus of examples 1, 2, 3, 4, or 5, wherein the compute die is a first compute die; and further comprising: a second compute die on the first side of the glass layer and on the PIC die, wherein the PIC die is electrically coupled with the second compute die.

Example 7 includes the apparatus of example 6, wherein the first compute die and the second compute die are optically or electronically coupled with each other through the PIC die.

Example 8 includes the apparatus of examples 1, 2, 3, 4, 5, 6, or 7, wherein the cavity is a first cavity, wherein the PIC die is a first PIC die; and further including: a second cavity in the glass layer, the second cavity extending from the first side of the glass layer; a second PIC die in the second cavity, wherein the compute die is on at least a portion of the second PIC die, wherein the second PIC die is electrically coupled with the compute die through the at least a portion of the second PIC die; and wherein the second PIC die is optically coupled with the glass layer.

Example 9 includes the apparatus of example 8, wherein the second PIC die is optically coupled with the glass layer using a photonic wire bond.

Example 10 includes the apparatus of examples 1, 2, 3, 4, 5, 6, 7, 8, or 9, wherein the PIC die includes a selected one or more of: a photonics transmission driver circuitry or transimpedance amplifier receiver circuitry, or wherein the compute die includes a selected one or more of: a photonics transmission driver circuitry or transimpedance amplifier receiver circuitry.

Example 11 includes the apparatus of examples 1, 2, 3, 4, 5, 6, 7, 8, 9, or 10, wherein the compute die is a system on chip (SOC), and wherein the SOC includes high-bandwidth memory (HBM).

Example 12 is a system comprising: a glass layer having a first side and a second side opposite the first side, wherein the glass layer is a solid glass layer; a cavity in the glass layer, the cavity extending from the first side of the glass layer; a photonics integrated circuit (PIC) die in the cavity; a photonic wire bond (PWB) optically coupled with the PIC die and the glass layer; a compute die on the first side of the glass layer and on at least a portion of the PIC die, wherein the PIC die is electrically coupled with the compute die; and an electronic integrated chip (EIC) on the PIC die, wherein the EIC is electrically coupled with the PIC die.

Example 13 includes the system of example 12, wherein the PWB is optically coupled with one or more waveguides in the glass layer.

Example 14 includes the system of examples 12 or 13, wherein the EIC includes electro-optical transmit, electro-optical receive, or electro-optical controller circuitry.

Example 15 includes the system of examples 12, 13, or 14, wherein at least a portion of the EIC is on the first side of the glass layer; and further comprising a through glass via extending from the second side of the glass layer to the first side of the glass layer, wherein the through glass via includes electrically conductive material, and wherein the electrically conductive material electrically couples the EIC with the second side of the glass layer.

Example 16 includes the system of examples 12, 13, 14, or 15, wherein the compute die is a first compute die; and further comprising: a second compute die on the first side of the glass layer and on the PIC die; and wherein the second compute die is electrically coupled with the PIC die.

Example 17 includes the system of examples 12, 13, 14, 15, or 16, wherein a surface of the PIC die is substantially planar with the first side of the glass layer.

Example 18 includes the system of examples 12, 13, 14, 15, 16, or 17, wherein the glass layer is a first glass layer; and further comprising a second glass layer that is an amorphous solid glass layer, wherein the second glass layer is physically coupled with the first glass layer, and wherein the second glass layer is below the first glass layer.

Example 19 is a method comprising: providing a glass layer that is a solid glass layer; forming a cavity within the glass layer; embedding a photonics integrated circuit (PIC) die within the glass layer; placing a compute die on the glass layer and on at least a portion of the PIC die; and forming a photonic wire bond (PWB) on a portion of the glass layer and/or a portion of the PIC that optically couples the PIC die with one or more waveguides in the glass layer.

Example 20 includes the method of example 19, wherein placing the compute die on the glass layer in the at least a portion of the PIC die further includes optically and/or electrically coupling the compute die with the PIC die.

What is claimed is:

1. An apparatus comprising:
a glass layer having a first side and a second side opposite the first side, wherein the glass layer is a solid glass layer;
a cavity in the glass layer, the cavity extending from the first side of the glass layer;
a photonics integrated circuit (PIC) die in the cavity;
a compute die on the first side of the glass layer and on at least a portion of the PIC die, wherein the PIC die is electrically coupled with the compute die; and
wherein the PIC die is optically coupled with the glass layer.

2. The apparatus of claim 1, wherein the PIC die is optically coupled with the glass layer using a photonic wire bond.

3. The apparatus of claim 1, wherein a surface of the PIC die is substantially planar with the first side of the glass layer.

4. The apparatus of claim 1, wherein the PIC die is electrically coupled with the compute die through the at least a portion of the PIC die.

5. The apparatus of claim 1, wherein the PIC die is optically coupled with the compute die through the at least a portion of the PIC die.

6. The apparatus of claim 1, wherein the compute die is a first compute die; and further comprising:
a second compute die on the first side of the glass layer and on the PIC die, wherein the PIC die is electrically coupled with the second compute die.

7. The apparatus of claim 6, wherein the first compute die and the second compute die are optically or electronically coupled with each other through the PIC die.

8. The apparatus of claim 1, wherein the cavity is a first cavity, wherein the PIC die is a first PIC die; and further including:
a second cavity in the glass layer, the second cavity extending from the first side of the glass layer;
a second PIC die in the second cavity, wherein the compute die is on at least a portion of the second PIC die, wherein the second PIC die is electrically coupled with the compute die through the at least a portion of the second PIC die; and
wherein the second PIC die is optically coupled with the glass layer.

9. The apparatus of claim 8, wherein the second PIC die is optically coupled with the glass layer using a photonic wire bond.

10. The apparatus of claim 1, wherein the PIC die includes a selected one or more of: a photonics transmission driver circuitry or transimpedance amplifier receiver circuitry, or wherein the compute die includes a selected one or more of: a photonics transmission driver circuitry or transimpedance amplifier receiver circuitry.

11. The apparatus of claim 1, wherein the compute die is a system on chip (SOC), and wherein the SOC includes high-bandwidth memory (HBM).

12. A system comprising:
a glass layer having a first side and a second side opposite the first side, wherein the glass layer is a solid glass layer;
a cavity in the glass layer, the cavity extending from the first side of the glass layer;
a photonics integrated circuit (PIC) die in the cavity;
a photonic wire bond (PWB) optically coupled with the PIC die and the glass layer;
a compute die on the first side of the glass layer and on at least a portion of the PIC die, wherein the PIC die is electrically coupled with the compute die; and
an electronic integrated chip (EIC) on the PIC die, wherein the EIC is electrically coupled with the PIC die.

13. The system of claim 12, wherein the PWB is optically coupled with one or more waveguides in the glass layer.

14. The system of claim 12, wherein the EIC includes electro-optical transmit, electro-optical receive, or electro-optical controller circuitry.

15. The system of claim 12, wherein at least a portion of the EIC is on the first side of the glass layer; and further comprising a through glass via extending from the second side of the glass layer to the first side of the glass layer, wherein the through glass via includes electrically conductive material, and wherein the electrically conductive material electrically couples the EIC with the second side of the glass layer.

16. The system of claim 12, wherein the compute die is a first compute die; and further comprising:
a second compute die on the first side of the glass layer and on the PIC die; and
wherein the second compute die is electrically coupled with the PIC die.

17. The system of claim 12, wherein a surface of the PIC die is substantially planar with the first side of the glass layer.

18. The system of claim 12, wherein the glass layer is a first glass layer; and further comprising a second glass layer that is an amorphous solid glass layer, wherein the second glass layer is physically coupled with the first glass layer, and wherein the second glass layer is below the first glass layer.

19. A method comprising:
providing a glass layer that is a solid glass layer;
forming a cavity within the glass layer;
embedding a photonics integrated circuit (PIC) die within the glass layer;
placing a compute die on the glass layer and on at least a portion of the PIC die; and
forming a photonic wire bond (PWB) on a portion of the glass layer and/or a portion of the PIC that optically couples the PIC die with one or more waveguides in the glass layer.

20. The method of claim 19, wherein placing the compute die on the glass layer in the at least a portion of the PIC die further includes optically and/or electrically coupling the compute die with the PIC die.
